(19) United States
(12) Patent Application Publication
(10) Pub. No.: US 2009/0088037 A1
(43) Pub. Date: Apr. 2, 2009

(54) LAMINATED FABRIC CONSTRUCTION WITH POLYOLEFIN COMPOSITIONS

(75) Inventors: Carmen A. Covelli, Chadds Ford, PA (US); Douglas K. Farmer, Greensboro, NC (US); James M. Lambert, Staunton, VA (US); Hong Liu, Waynesboro, VA (US); Robert O. Waldbauer, Waynesboro, VA (US); Young D. Nguyen, Crozet, VA (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA North America S.ar.l., Wilmington, DE (US)

(21) Appl. No.: 12/208,813

(22) Filed: Sep. 11, 2008

Related U.S. Application Data
(60) Provisional application No. 60/975,918, filed on Sep. 28, 2007.

(51) Int. Cl. B32B 5/18; C08F 210/00; B32B 27/00

(52) U.S. Cl. 442/76; 526/348; 428/523; 428/319.3; 442/59

(57) ABSTRACT

Articles comprising multiple layers are included. The multiple layer articles may include fabrics, foams, films, fiber in combination with a polyolefin composition such as a film, powder, or nonwoven.

### CROSS-REFERENCE TO RELATED APPLICATION

This application claims benefit of priority from Provisional Application No. 60/975,918 filed Sep. 28, 2007.

### BACKGROUND OF THE INVENTION

1. Field of the Invention

The present invention relates to articles including a multiple layer construction. The layers include fabric and/or polyurethane foam in combination with a polyolefin composition.

2. Summary of Related Technology

Polyolefins can be used as adhesives for various substrates. Such thermoplastic adhesives often require heat and pressure to develop adequate bonding strength. Hot-melt adhesives, although environmentally safe and easily applied as films, generally have high set and poor recovery when subject to repeated stretch cycles. Therefore, adhesives that overcome the performance concerns of hot-melt adhesives are needed. Desirably, such adhesives will also provide other benefits to the fabric such as flexibility, shape retention and air permeability compared to conventional thermoplastic polyurethane and hot-melt adhesives.

### SUMMARY OF THE INVENTION

Some embodiments provide a multi-layer article including at least two layers, one of which is a polyolefin composition. The polyolefin composition may form one of the layers, for example, as a polyolefin composition on a substrate. The polyolefin composition may be in any suitable form such as a film, non-woven, powder, dispersed powder, melt, and combinations thereof. The polyolefin composition may be placed adjacent to or between the layers and also may provide adhesion, moldability, shape retention, and flexibility properties for the article.

Some embodiments provide an article including multiple layers (multi-layer) which has been pressed, laminated and/or molded. This article includes at least two layers where one of the layers is a polyolefin composition in the form of a film, non-woven, or melt.

A further embodiment provides an article including at least one fabric layer and at least one polyolefin composition selected from the group consisting of films, non-woven, melt, powder, dispersed powder and combinations thereof.

### DETAILED DESCRIPTION OF THE INVENTION

As used herein, the term “porous” refers to a substrate that includes voids or holes in the surface or at any point within or through the thickness of the substrate or to any material of which the articles of the present invention may come into contact. The substrate may be self-supporting and continuous or discontinuous and optionally include an additional substrate.

As used herein, the term “pressing” or “pressed” refers to an article that has been subjected to heat and/or pressure to provide a substantially planar structure.

As used herein, the term “foam” refers to any suitable foam that may be used in fabric construction such as polyurethane foam.

As used herein, the term “dispersion” refers to a system in which the disperse phase consists of finely divided particles, and the continuous phase can be a liquid, solid or gas.

As used herein, the term “article” refers to an article which comprises a film, non-woven, powder, dispersed powder or shaped article and a substrate, for example a textile fabric, which may or may not have at least one elastic property, in part, due to the application of a dispersion or shaped article as described herein. The article may be in any suitable configuration such as one-dimensional, two-dimensional and/or three-dimensional.

As used herein, the term “fabric” refers to a knitted, woven or nonwoven material. The knitted fabric may be flat knit, circular knit, warp knit, narrow elastic, and lace. The woven fabric may be of any construction, for example sateen, twill, plain weave, oxford weave, basket weave, and narrow elastic. The nonwoven material may be meltblown, spun bonded, wet-laid, carded fiber-based staple webs, and the like.

As used herein, the term “substrate” refers to any material to which the articles of the present invention may come into contact. A substrate can be substantially one dimensional as is a fiber, two dimensional as in a planar sheet, or a three dimensional article or a bumpy sheet. A planar sheet for example may comprise textile fabric, paper, flocked article, and web. A three dimensional article for example may comprise leather and foam. Other substrates may comprise wood, paper, plastic, metal, and composites such as concrete, asphalt, gymnasium flooring, and plastic chips.

As used herein, the term “hard yarn” refers to a yarn which is substantially non-elastic.

As used herein, the term “molded” article refers to a result by which the shape of an article or shaped article is changed in response to application of heat and/or pressure.

As used herein, the term “derived from” refers to forming a substance out of another object. For example, a film may be derived from a dispersion which can be dried.

As used herein, the term “modulus” refers to a ratio of the stress on an item expressed in force per unit linear density or area.

As used herein, the term “polyolefin” is meant to include polyolefins prepared from C₂ to C₂₀ monomers. This includes copolymers and terpolymers such as ethylene-propylene copolymers. Examples of useful polyolefin copolymers are disclosed in U.S. Pat. No. 6,867,260 to Datta et al., incorporated herein by reference.

In some embodiments are multiple layer articles which include at least one layer of a polyolefin composition. These articles have at least two layers including at least one polyolefin composition. The polyolefin composition may form one of the layers, for example, as polyolefin composition on a substrate. The polyolefin composition may be in any suitable form such as a film, powder, non-woven, melt, dispersed powder, dry powder, and combinations thereof. The polyolefin composition may be placed adjacent to or between the layers and also may provide stretch and recovery, increased elastic modulus, adhesion, moldability, shape retention, and flexibility properties for the article. These articles may be formed into fabrics and/or garments.

A variety of different polyolefin compositions are useful with articles of some embodiments. For example, the articles of some embodiments may include a polyolefin solution or film cast from a solution (the solution includes a solvent such as boiling xylene, boiling heptane, hot 1,2,4-trichlorobenzene, hot ethylene glycol monobutylether, or hot orthodichlorobenzene) an aqueous dispersion including a polyolefin powder and optionally a solvent, or a substantially solvent free aqueous dispersion. For example, a polyolefin solution such as a spinning solution or gel may be used to cast a film, according to some embodiments of the present invention.

In an embodiment where the article includes a multiple layer article including three or more layers where one layer is a polyolefin composition, the polyolefin composition may be an intermediate layer between two fabric layers, between two foam layers, between a fabric layer and a foam layer, or adjacent to a foam layer which is adjacent to a fabric layer. Combinations of these fabric/foam/polyolefin composition arrangements are also contemplated. For example, the article may include, in order, a fabric layer, a foam layer, a polyolefin composition layer, a foam layer, and a fabric layer. This article includes two separate fabric layers, two separate foam layers and a polyolefin composition layer. In any of these embodiments, the polyolefin composition may be a film, non-woven, powder, melt, dispersed powder, or combinations thereof. In addition, the article may include one or more polyolefin film and one or more layer of a polyolefin in a different form.

In an embodiment that includes two or more layers, the polyolefin composition may form the external layer. Including the polyolefin composition on an external surface forms many advantageous functions. For example, the polyolefin composition may provide an anchor or area of increased friction to reduce the relative movement between the article including the polyolefin composition and an external substrate. This is particularly useful when the article is an undergarment including a skin-contacting surface (where the wearer's skin is the substrate). Alternatively, the substrate may be outer clothing which is in contact with the polyolefin composition of the inventive article. Where the substrate is outer clothing of a wearer and the article is worn as an undergarment, the article prevents or reduces the relative movement of the outer garment. In addition, an outer garment (e.g. a dress) may include a polyolefin composition to maintain the relative placement of an inner garment (e.g. a slip).

After the layers of fabric, foam, and the polyolefin composition have been selected, they may subsequently be adhered through pressing or molding to form flat or shaped articles. The processes to prepare the pressed and molded articles of some embodiments include the use of pressure and heat as necessary. For example, heat may be applied at about 150° C. to about 200° C. or about 160° C. to about 180° C., including about 165° C. for a sufficient time to achieve a molded article. Suitable times for application of heat include, but are not limited to, from about 30 sec to about 360 sec including from about 45 sec to about 120 sec. Bonding may be effected by any known method, including but not limited to, microwave, infrared, conduction, ultrasonic, pressure application over time (i.e. clamping) and combinations thereof.

Due the application of heat and pressure to the articles including polyolefin films or non-wovens, powder, and melt and given that films and fabrics are themselves porous materials, it is recognized that the film or non-woven may partially or completely impregnate the fabric or foam of the article. For example, the polyolefin composition may form a layer which is partially separate from the surrounding layers, or may be completely transferred to the surrounding layer or layers to form an integrated article without a distinguishably separate polyolefin composition layer.

One application of the multi-layer articles of the present invention is body-shaping garments such as brassieres (especially in cups or wings) and men's undergarments. These articles can provide the desirable features of comfort, body shaping and support while still providing comfort, breathability, air permeability, moisture/vapor transport, wicking, and combinations thereof. In the articles of some embodiments of the present invention, the layers may take on predetermined shapes and may be arranged in predetermined orientations relative to each other in the design of a molded or shaped article such as the cups of a brassiere construction. The layers of these fabrics may be used either alone or in combination with other materials that are sewn, glued or otherwise applied to the fabrics.

In some embodiments there is a system for the construction of a body-shaping garment with integrated shaping ability provided by the fabric. This system of construction may be used in a variety of different garment constructions such as activewear, sportswear, men's and women's intimate apparel such as bras, underwear, panties, shaping garments, legwear and hosiery such as pantyhose, ready-to-wear garments such as denim jeans, camisoles, tailored shirts, and pants among others. This construction may be applied to any formable body area. While many advantages of the fabric constructions are included, it is further recognized that the utility is not limited to garments, but also finds applicability with any shapeable or formable medium, including cushions for furniture which are also subject to movement and potential slipping of a fabric in contact with the shapeable area.

In order to add additional support and other features, the polyolefin composition may be added to different areas of the article. For example, when a film is used, it may either extend through the entire area of the article or to a selected portion to provide different benefits. For example, a brassiere may include a layered fabric of some embodiments in the cup portion. In the brassiere cup, it can be useful to use a portion of film in the lower portion of the cup for support, in a central portion of the cup for modesty, in the side portion for shaping, or in specific areas for embellishment or decoration.

Reducing the amount of film in a multi-layer fabric to meet the needs of a fabric may also increase the air permeability of the fabric. Air permeability may also be increased by altering the film to make it porous or to become porous (i.e. “latent” breathability) or by perforating the film.

The polyolefin compositions provide additional benefits when used in a garment. These benefits include shape retention, shaping ability, adhesion, maintaining a fraction of the substrates, moisture management, and vapor permeability.

The polyolefin compositions may be added in other constructions depending on the desired function which may be a visual aesthetic. The polyolefin films, non-woven, powder, dispersed powder or melt may be added to an article, fabric or garment to be molded into a design, to adhere embellishments such as decorative fabrics and glitter, in the form of a label or logo, and combinations thereof.

In some embodiments, the polyolefin composition may act as an adhesive to attach two or more layers of fabric or foam, or to attach a layer of fabric to foam. One suitable method for accomplishing this is to apply a powder or dispersed powder or melt to a layer by any suitable method. Methods for applying the dispersions of some embodiments include spraying, kissing, printing, brushing, dipping, padding, dispensing, metering, painting, sprinkling and combinations thereof. This may be followed by application of heat and/or pressure.

Other adhesives may be included in the multiple layer articles of some embodiments of the invention. Examples of adhesives include thermoset or thermoplastic adhesives, pressure sensitive adhesives, hot melt adhesives, and combinations thereof. The adhesive may be used to adhere the different layers and may be applied to any of the fabric, foam or polyolefin films, non-woven, powder, dispersed powder, or melt. Moreover, the polyolefin composition may also be used as an adhesive in contact with one or more layer such as any fabric, foam or polymer film such as the polyurethaneurea films described in U.S. Pat. No. 7,240,371.

As described above, there are a variety of fabric constructions that are useful for the articles of the present invention. The polyolefin composition included in the articles may be in any suitable form in any of these embodiments. In addition, the polyolefin composition may provide structural properties, flexibility, adhesion, or any combination of these. The order of layer arrangement may be (1) fabric layer, foam layer, polyolefin layer; (2) fabric layer, foam layer, polyolefin layer, foam layer, fabric layer; (3) fabric layer, polyolefin layer, fabric layer; (4) foam layer, polyolefin layer, foam layer; (5) foam layer, polyolefin layer; (6) fabric layer, polyolefin layer; or any combination of these which may be combined to achieve more layers in the fabric construction. An adhesive may be included adjacent to or between layers to adhere any of the layers. Alternatively, the polyolefin composition may be the adhesive.

A variety of different fibers and yarns may be used with the fabrics of some embodiments. These include cotton, wool, acrylic, polyamide (nylon), polyester, spandex (elastane), regenerated cellulose, rubber (natural or synthetic), bamboo, silk, soy or combinations thereof.

The present invention can also provide shaped articles which may or may not be adhesive that can be coated on a release paper, whereby polyolefin compositions of the invention can be used for bonding and lamination to substrates including textile fabrics. The adhesion can be activated by applying heat and/or pressure onto a substrate and the adhesive film with a residence time of less than one minute, for example, from about 15 seconds to about 60 seconds. The thus bonded articles have good stretch/recovery properties and are expected to be durable in normal wear and wash cycles.

The polyolefin compositions of some embodiments are particularly suitable for adhesive shaped articles, which can be used for fabric bonding, lamination, and adhesion purposes when applied with heat and pressure for a relatively short period of time. Pressures, can for example, range from about atmospheric pressure to about 60 psi and times can range from less than about one second to about 30 minutes in accordance with the bonding method used.

Such shaped articles may be made by casting the melt or dispersed powder onto a release paper and drying to remove water at temperatures below about 100° C. through commercially available processes to form a film on the paper. The formed film sheets can be slit into strips of desired width and wound-up into spools for later use in applications to form stretch articles, for example textile fabrics. Examples of such applications include: stitch-less or seamless garment constructions; seam seal and reinforcement; labels and patches bonding to garments; and localized stretch/recovery enhancement. The adhesion bonding can be developed in the temperature range of from about 100° C. to about 200° C., such as from about 130° C. to about 200° C., for example, from about 140° C. to about 180° C., in a period of 0.1 seconds to several minutes, for example, less than about one minute. Typical bonding machines are Sew Free (commercially available from SewSystems in Leicester, England), Macpi hemming machine (commercially available from the Macpi Group in Brescia, Italy), Framis hot air welding machine (commercially available from Framis Italy, s p.a. in Milano, Italy). This bonding is expected to be strong and durable when exposed to repeated wear, wash, and stretch in a textile fabric garment.

The film, non-woven, melt, or shaped article may be pigmented or colored and also may be used as a design element in that regard.

In addition, articles with laminated films or non-wovens can be molded. For example, fabric can be molded under conditions appropriate for the hard yarn in the fabric. Also, molding may be possible at temperature which will mold the shaped article or dispersion, but below temperatures suitable for molding the hard yarn.

Lamination can be carried out to secure the shaped article to a fabric using any method wherein heat is applied to the laminate surface. Methods of heat application include, for example, ultrasonic, direct heat, indirect heat, and microwave.

Methods and means for applying the polyolefin compositions of some embodiments include, but are not limited to: roll coating (including reverse roll coating); use of a metal tool or knife blade (for example, pouring a dispersion onto a substrate and then casting the dispersion into uniform thickness by spreading it across the substrate using a metal tool, such as a knife blade); spraying (for example, using a pump spray bottle); dipping; painting; printing; stamping; and sprinkling, impregnating the article. These methods can be used to apply the melt, powder, or dispersed powder directly onto a substrate without the need of further adhesive materials and can be repeated if additional/heavier layers are required. The dispersions, powder or melt can be applied to any fabrics of knits, wovens or nonwovens made from synthetic, natural, or synthetic/natural blended materials for coating, bonding, lamination and adhesion purposes. The water in the dispersion can be eliminated with drying during the processing (for example, via air drying or use of an oven), leaving the precipitated and coalesced polyolefin layer on the fabrics to form an adhesive bond.

The thickness of the films, melts, solutions, and dispersions may vary depending on the application. In the case of dry shaped articles, the final thickness may, for example, range from about 0.1 mil to about 250 mil, such as from about 0.5 mil to about 25 mil, including from about 1 to about 6 mil (one mil=one thousandth of an inch).

Suitable thicknesses include about 0.5 mil to about 12 mil, about 0.5 to about 10 mil, and about 1.5 mil to about 9 mil. For aqueous dispersions, the amount used may, for example, range from about 2.5 g/m² to about 6.40 kg/m², such as from about 12.7 to about 635 g/m², including from about 25.4 to about 152.4 g/m².

Types of planar sheets and tapes that can be coated with the polyolefin compositions include, but are not limited to, textile fabrics, including wovens and knits; nonwovens; scrim and leather (real or synthetic), paper, metal, plastic, polyurethaneurea film, and combinations thereof.

Other articles that can be produced using the polyolefin compositions of some embodiments include, but are not limited to: apparel, which includes any type of garment or article of clothing; knitted gloves; upholstery; hair accessories; bed sheets; carpet and carpet backing; conveyor belts; medical applications, such as stretch bandages; personal care items, including incontinence and feminine hygiene products; and footwear. Articles coated with polyolefin compositions may be used as sound suppression articles.

Non-elastic fabrics laminated to polyolefin compositions can have improved stretch and recovery and improved molding properties.

Articles the polyolefin compositions of some embodiments may be molded. The articles may be made with multiple layers of substrate and polyolefin composition. The multi-layered articles also may be molded. Molded and non-molded articles may have different levels of stretch and recovery. The molded articles may be used in a body shaping or body supporting garment, such as a brassiere.

Examples of apparel or garments that can be produced using the polyolefin compositions of some embodiments, include but are not limited to: undergarments, brassieres, panties, lingerie, swimwear, shapers, camisoles, hosiery, sleepwear, wetsuits, ties, scrubs, space suits, uniforms, hats, garters, sweatbands, belts, activewear, outerwear, rainwear, cold-weather jackets, pants, shirtings, dresses, blouses, men's and women's tops, sweaters, corsets, vests, knickers, socks, knee highs, dresses, blouses, aprons, tuxedos, bisht, abaya, hijab, jilbab, thoub, burka, cape, costumes, diving suit, kilt, kimono, jerseys, gowns, protective clothing, sari, sarong, skirts, spats, stola, suits, straitjacket, toga, tights, towel, uniform, veils, wetsuit, medical compression garments, bandages, suit interlinings, waistbands, and all components therein.

Another aspect of the invention is an article comprising the shaped article and a substrate wherein the shaped article and the substrate are attached to form a laminate whereby coefficient of friction of the elastic laminate is greater than that of the substrate alone. Examples of this are a waistband with a coating or film comprising the polyolefin composition which prevents slippage of the garment from another garment such as a blouse or shirt, or alternately prevents slippage of the waistband on the skin of the garment wearer.

The features and advantages of the present invention are more fully shown by the following examples which are provided for purposes of illustration, and are not to be construed as limiting the invention in any way.

### EXAMPLES

Each of the polyolefin compositions as set forth in Table 1 was included in one half of a bra mold to provide a control cup and an inventive cup (which included the polyolefin composition) which were simultaneously molded under identical conditions. A conventional foam bra cup molding apparatus was heated to 180° C. A nylon/LYCRA® spandex warp-knitted fabric was prelaminated to a 5 mm thick polyurethane foam sheet to form a fabric/foam laminate. Two such fabric/foam laminates were placed foam-to-foam, with the fabric layers facing out. One each of the four example polyolefin compositions, in turn, was inserted between the foam layers and covering one half of the mold, i.e., one cup. The mold was closed with 5 bar pressure and held closed for 120 seconds. The mold was then opened and the molded cups were removed and allowed to cool.

The sets of test/control cups were evaluated (shape, shape retention, height, smoothness, and tactility). The cups were then subjected to five home laundering cycles. The cups were again evaluated. The result of the testing is shown in Table 2.

TABLE 1
Polyolefin Compositions

| | Example | | | |
|---|---|---|---|---|
| | 1 | 2 | 3 | 4 |
| Polymer (1) | VISTAMAXX ™ | VISTAMAXX ™ | VISTAMAXX ™ 2125 | VISTAMAXX ™ 2125 |
| | 2125 specialty | 2125 specialty | specialty elastomer | specialty elastomer |
| | elastomer | elastomer | | |
| Polymer (2) | none | polypropylene | none | polypropylene |
| Construction | Single-layer | Double-layer | Spunbond/meltblown | Spunbond/meltblown |
| | spunbond | spunbond | | construction |
| | | (1)/(1)/(2) | | (2)/(1)/(1)/(2) |
| Basis weight | 60 g/m² | 75 g/m² (60 g/m² + | 128 g/m² (120 g/m²/8 | 128 g/m² (4 g/m²/60 |
| | | 15 g/m²) | g/m²) | g/m²/60 g/m²/4 |
| | | | | g/m²) |

TABLE 2
Observations

| Inventive Laminate | Corresponding Control |
|---|---|
| Molded shape more pronounced, taller | Less defined, shorter |
| Shape retained after laundering | After laundering cup had |
| | “lumpy/bumpy appearance |
| Molded shape was integrated and maintained | When cup was reversed, |
| when cup was reversed (inside out) | surface was dimpled |

As can be seen in Table 2, the inventive laminate structures including the polyolefin compositions demonstrated improved properties over the control.

While the present invention has been described in an illustrative manner, it should be understood that the terminology used is intended to be in a nature of words or description rather than of limitation. Furthermore, while the present invention has been described in terms of several illustrative embodiments, it is to be appreciated that those skilled in the art will readily apply these teachings to other possible variations of the invention.

What is claimed is:

1. An article comprising multiple layers comprising at least two layers; wherein of said layers comprises a at least one, polyolefin composition selected from the group consisting of film, non-woven, powder, melt, dispersed powder, and combinations thereof.

2. The article of claim 1, wherein said polyolefin composition is cast from polyolefin melt

3. The article of claim 1, wherein the polyolefin composition is between the at least two layers.

4. The article of claim 1, wherein said at least two layers are selected from the group consisting of fabric layers, foam layers, polymer film layers, fiber layers, and combinations thereof.

5. The article of claim 1, wherein said at least two layers include at least two fabric layers and at least two foam layers.

6. The article of claim 5, wherein the polyolefin composition is adjacent to a foam layer on each side and each foam layer is adjacent to a fabric layer.

7. The article of claim 1, wherein the article is molded or pressed.

8. The article of claim 1, wherein the polyolefin composition extends throughout the entire area of the multiple layer article.

9. The article of claim 1, wherein the polyolefin composition extends to a portion of the area of the multiple layer article.

10. The article of claim 1, wherein at least two polyolefin compositions are included.

11. The article of claim 1, wherein said polyolefin composition is porous or perforated.

12. The article of claim 1 in the form of a garment.

13. The article of claim 4, further comprising an at least one adhesive between two or more layers.

14. The article of claim 13, wherein said adhesive is a hot melt adhesive, a contact adhesive, a thermoset, a thermoplastic, or a polyurethaneurea aqueous dispersion.

15. An article comprising multiple layers comprising:
(a) at least two layers; and
(b) a polyolefin composition selected from the group consisting of a melt, a solution, a dispersed powder, and combinations thereof.

16. The article of claim 15, wherein said a polyolefin composition is an adhesive.

17. The article of claim 15, wherein said polyolefin composition is between layers.

18. The article of claim 15, wherein said at least two layers are selected from the group consisting of fabric layers, foam layers, polymer film layers, fiber layers and combinations thereof.

19. The article of claim 15, wherein the polyolefin composition is sprayed onto a layer.

20. The article of claim 15 further comprising a garment.

21. An article comprising:
(a) at least two layers; and
(b) at least one a polyolefin composition selected from the group consisting of film, non-woven, melt, solution, dispersed powder, and combinations thereof;
wherein said polyolefin composition is laminated between said at least two layers and said article has been molded.

22. The article of claim 21, wherein said at least two layers are selected from the group consisting fabric layers, foam layers, polymer film layers, fiber layers, and combinations thereof.

23. The article of claim 21, further comprising an additional polyolefin composition selected from the group consisting of melt, solution, dispersed powder, and combinations thereof.

24. The article of claim 21, wherein said article is a garment and said polyolefin composition reduces relative movement between a garment and a substrate.

25. The article of claim 21, wherein said substrate is skin.
